(19) United States
(12) Patent Application Publication
(10) Pub. No.: US 2012/0072043 A1
(43) Pub. Date: Mar. 22, 2012

(54) POWER DISTRIBUTION

(75) Inventor: Klaus Arzig, Feucht (DE)

(73) Assignee: SIEMENS AKTIENGESELLSCHAFT, Muenchen (DE)

(21) Appl. No.: 13/322,714

(22) PCT Filed: May 29, 2009
(86) PCT No.: PCT/EP2009/004042

§ 371 Date: Nov. 28, 2011

(51) Int. Cl. G06F 1/26

(52) U.S. Cl. 700/297

(57) ABSTRACT

A power distribution system has a field device level, a hierarchically higher station level, and an instrumentation and control level hierarchically higher than the station level. A function of field devices belonging to the field level, a function of station devices belonging to the station level, and a function of instrumentation and control devices belonging to the instrumentation and control level are defined by parameters. A plurality of separate computing devices are connected to each other by a communication network and form a distributed computer system. The field devices, the station devices, and the instrumentation and control devices are connected to the distributed computer system or are formed by individual or a plurality of computer devices. The parameters for determining the function of the devices are distributed over two different computer devices. The devices access the parameters via the communication network.

The invention relates to a power distribution installation having a field device level, a hierarchically superordinate station level and a control level which is hierarchically superordinate to the station level, with the method of operation of the field devices which are associated with the field level, the method of operation of the station devices which are associated with the station level, and the method of operation of the control devices which are associated with the control level being defined by parameters. Power distribution installations such as these are in general normally used nowadays, for example in electrical power distribution networks.

The invention is based on the object of specifying a power distribution installation, in which the parameters can be changed more easily than in previous power distribution installations.

This object is achieved by a power distribution installation having the features as claimed in patent claim 1. Advantageous refinements of the power distribution installation according to the invention are specified in dependent claims.

The invention accordingly provides that a multiplicity of separate computer devices are connected to one another via a communication network and form a local computer system for the power distribution installation, the field devices in the field level, the station devices in the station level and the control devices in the control level are connected to the local computer system, or are formed by one or more computer devices in the local computer system, and the parameters for definition of the method of operation of the field devices, of the station devices and of the control devices are distributed between at least two different computer devices in the local computer system, and the field devices, the station devices and the control devices access the parameters via the communication network.

One major advantage of the power distribution installation according to the invention can be seen in that, in this power distribution installation, those parameters which define the method of operation of the field, station and control devices can be changed locally, simply by accessing the local computer system in the power distribution installation. In contrast to conventional power distribution installations, in which the parameters are implemented or stored in the individual devices and therefore also have to be changed individually for each device, device-independent reconfiguration can be carried out in the power distribution installation according to the invention. It is therefore possible to reconfigure the power distribution installation and to change the power distribution in the power distribution network very much more quickly and very much more cost-effectively when less alternative power (for example wind power or electrovoltaic power) than expected is available, for example because of an unexpected change in the weather.

A further major advantage of the power distribution installation according to the invention is that the parameters are distributed in the local computer system. This is because local storage of the parameters makes it possible to take account of the spatial or geographic arrangement of the field, station and control devices and to store the parameters where they are required; this reduces the load on the communication network as well as transmission problems and transmission errors in the transmission of the parameters to the respective field, station and control devices. In addition, the parameters can be stored redundantly, in order to avoid any data loss in the event of failure of individual computer devices.

According to one particularly preferred refinement, the control software which controls the power distribution by the power distribution installation and/or the protection of the power distribution installation, in that it sets or changes the parameters for definition of the method of operation of the field devices, of the station devices and of the control devices, is distributed between different computer devices in the local computer system. Distribution of the computation power in this way offers the advantage that it is also possible to use those computer devices which would not be suitable on their own for handling and running all of the control software, but are actually able to carry out at least task elements autonomously.

Preferably, the control software has power distribution modules which control the power distribution by the power distribution installation at least as a function of the power availability and the power demand by setting or changing the parameters autonomously. Provision of separate power distribution modules offers the advantage that the computation power for local power distribution can be provided specifically where it is spatially or geographically required; this increases the processing rate and reduces the error probability. Alternatively or additionally, the control software may also have separate protection modules which autonomously control the protection of the power distribution installation by setting or changing the parameters.

The power distribution modules are preferably designed such that they autonomously identify whether relevant power suppliers or power consumers have been added to or removed from the power distribution network, and such that they adapt the parameters depending on the change which has occurred in the network structure.

With respect to optimum distribution of the computation power and memory utilization in the computer devices in the local computer system, it is considered to be advantageous for the control software to have a central management program part which checks the association of the power distribution modules and/or of the protection modules with the individual computer devices in the local computer system, and if necessary changes them, as a function of the instantaneous availability and/or of the instantaneous operating status of the computer devices, regularly, irregularly or on an event-controlled basis.

Preferably, local sections of the power distribution installation are associated with individual power distribution modules and/or individual protection modules, for which the power distribution modules control the power distribution as a function of the local power availability and the local power demand, and/or the protection modules locally control the protection.

It is also considered to be advantageous for the central management program part to be designed such that it chooses the association of the power distribution modules and/or of the protection modules with the computer devices in the local computer system as a function of the geographic location of the computer devices and the geographic location of the local sections, to be precise such that, for the association of the power distribution modules and/or of the protection modules with the computer devices, those computer devices which are located in the respective local sections or computer devices which are adjacent thereto are preferred over those computer devices which are further away from the respective local sections.

Preferably, at least one of the power distribution modules is suitable for predicting the future power demand in its local section in order to prepare optimum power distribution.

By way of example, the power distribution modules and/or the protection modules may be each associated with a single computer device in the local computer system.

Preferably, the central management program part is distributed between at least two computer devices in the local computer system, since, because of its complexity, it generally requires a relatively large amount of computation power. Preferably, the central management program part is formed by management program part modules which are associated with at least two computer devices in the local computer system.

In order to avoid data loss, it is considered to be advantageous if the communication connection between at least two computer devices in the local computer system and/or between at least one field device at the field level, a station device at the station level or a control device at the control level and at least one of the computer devices in the local computer system is provided redundantly.

By way of example, the communication via the communication network at least also can take place in accordance with the IEC61850 Protocol. The IEC61850 Protocol makes it possible to process voltage and current values in the local computer system in a particularly simple manner.

The invention also relates to a method for operation of a power distribution installation having a field device level, a hierarchically superordinate station level and a control level which is hierarchically superordinate to the station level, with the method of operation of the field devices which are associated with the field level, the method of operation of the station devices which are associated with the station level, and the method of operation of the control devices which are associated with the control level being defined by parameters.

According to the invention, the parameters for definition of the method of operation of the field devices, of the station devices and of the control devices are distributed between at least two different computer devices in a local computer system, and the field devices, the station devices and the control devices access the parameters via a communication network.

With regard to the advantages of the method according to the invention, reference should be made to the advantages of the power distribution installation according to the invention, since the advantages of the power distribution installation according to the invention correspond essentially to those of the method according to the invention.

It is considered to be particularly advantageous if local sections of the power distribution installation are associated with individual power distribution modules and/or individual protection modules for which the power distribution modules locally control the power distribution and/or the protection modules locally control the protection, and if the association of the power distribution modules and/or of the protection modules with the computer devices in the local computer system is chosen as a function of the geographic location of the computer devices and the geographic location of the local sections, to be precise such that, for the association of the power distribution modules and/or of the protection modules with the computer devices, those computer devices which are located in the local sections, which are associated with the power distribution modules and/or protection modules, or in the vicinity thereof are preferred over computer devices which are further away.

The invention will be explained in more detail in the following text with reference to the figures in which, by way of example:

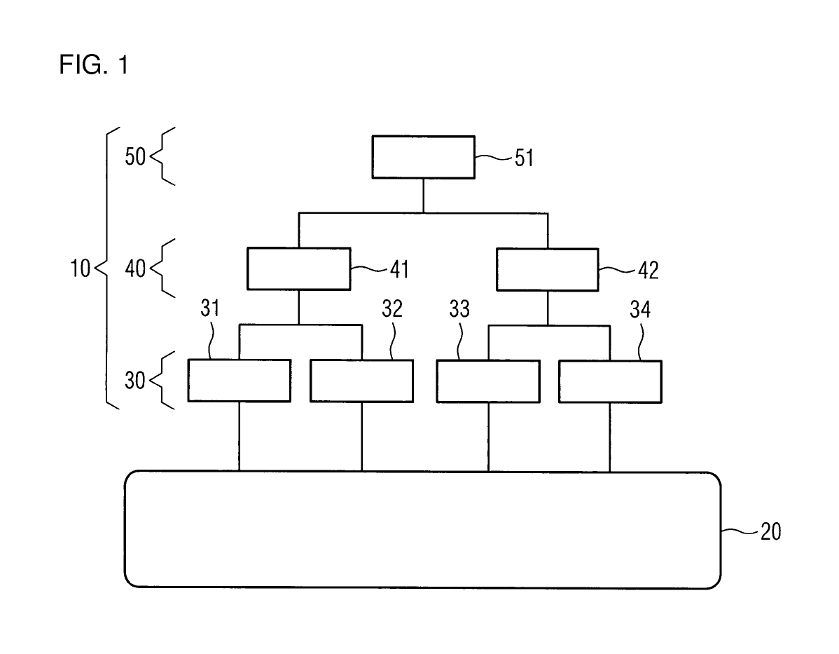

FIG. 1 shows a power distribution installation which is not the subject of a claim, for general explanation,

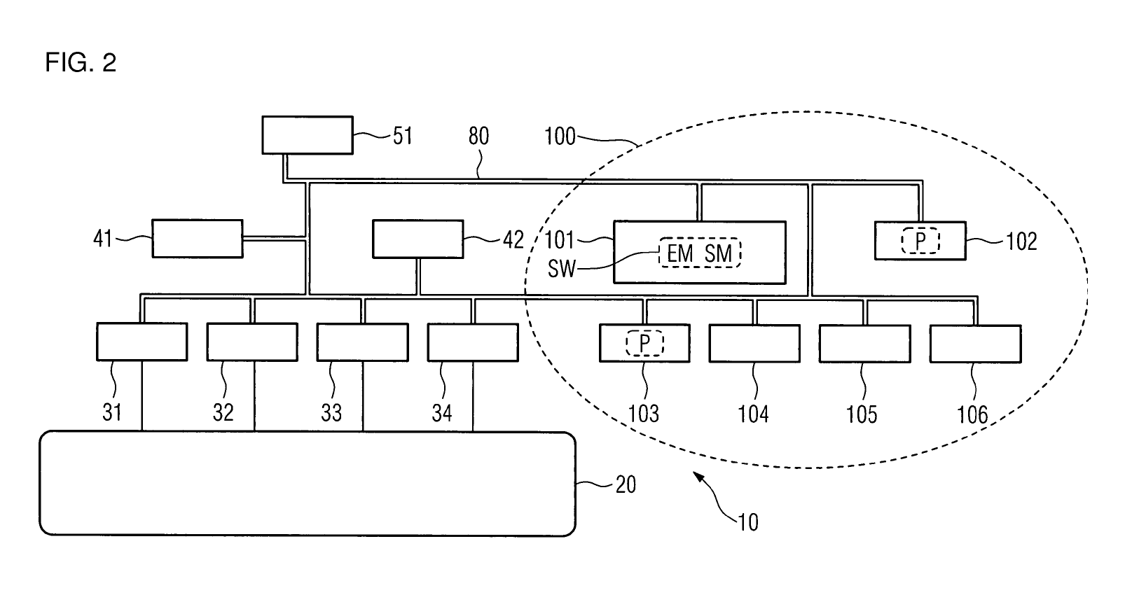

FIG. 2 shows one exemplary embodiment of a power distribution installation according to the invention, on the basis of which one exemplary embodiment of the method according to the invention will also be explained, and

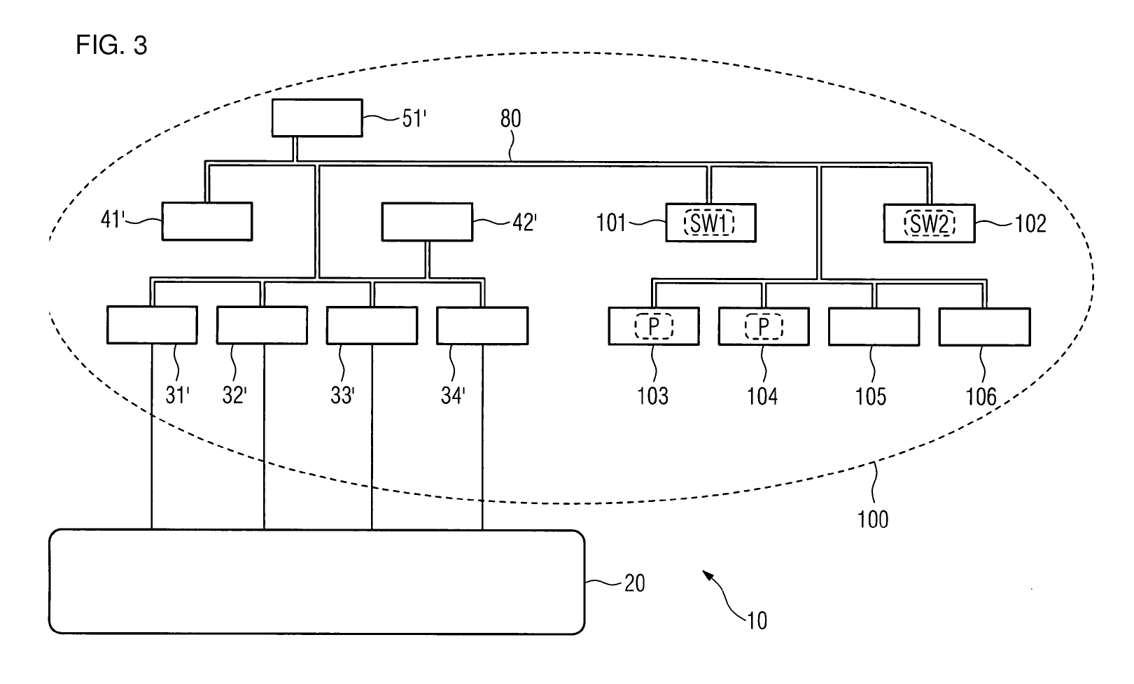

FIG. 3 shows a further exemplary embodiment of a power distribution installation according to the invention.

The same reference symbols are used for identical or comparable components in the figures.

FIG. 1 shows a power distribution installation 10, which is connected to a power supply network 20, which is not illustrated in any more detail. The power distribution installation 10 is hierarchically structured and has a field device level 30, with which field devices 31, 32, 33 and 34 33 are associated. By way of example, the field devices 31, 32, and 34 may be formed by protection devices, meters, actuators, switches, switchgear assemblies or the like. The field devices 31, 32, 33 and 34 are connected directly or indirectly to the power supply network 20, for example via instrument transformers, switching elements or other devices or appliances.

A station level 40 is hierarchically superordinate to the field device level 30 and is formed, for example, by station devices 41 and 42.

Furthermore, the power distribution installation 10 has a control level 50, which is hierarchically superordinate to the station level 40 and may comprise one or more control devices 51.

The method of operation of the field devices 31, 32, 33 and 34 associated with the field level 30, the method of operation of the station devices 41 and 42 associated with the station level 40, and the method of operation of the control device 51 associated with the control level 50 are each defined by parameters which are implemented or stored in the respective devices. When the intention is to change the configuration of the power distribution installation 10, all the devices affected must be reconfigured, which results in a not inconsiderable amount of effort, since the reconfiguration in general affects all hierarchy levels 30, 40 and 50.

FIG. 2 shows one exemplary embodiment of a power distribution installation 10 according to the invention. In this power distribution installation 10, the field devices 31, 32, 33 and 34, the station devices 41 and 42 and the control device 51 are connected to one another via a communication network 80. In addition, they are connected via this communication network 80 to a local computer system 100 for the power distribution installation 10.

The local computer system 100 in this exemplary embodiment comprises six computer devices 101, 102, 103, 104, 105 and 106. Control software SW is installed on one of these six computer devices—for example the computer device 101—or is installed in a distributed manner between a plurality of these computer devices, and controls the power distribution through the power distribution installation 10, and/or the protection of the power distribution installation 10.

The purpose of the control software SW is, inter alia, to adjust and/or to change the parameters P for definition of the method of operation of the field devices 31, 32, 33, 34, of the station devices 41 and 42 and of the control device 51, and to store the respectively applicable parameters P in the local computer system 100. The control software SW will preferably store the parameters P for the field, station or control devices in those computer devices in the local computer system 100 which are physically the closest to the respective field, station or control devices, thus resulting in the parameters P being distributed between at least two different computer devices in the local computer system 100. In the exemplary embodiment shown in FIG. 2, the parameters P are, for example, stored distributed between the computer devices 102 and 103.

The field devices 31, 32, 33, 34, the station devices 41 and 42 and the control device 51 receive their respective parameters P, which are stored in the local computer system 100, via the communication network 80.

The control software SW preferably has one or more power distribution modules EM which autonomously control the power distribution through the power distribution installation, at least as a function of the power availability and the power demand, by adjusting or changing the parameters P for definition of the method of operation of the field devices, of the station devices and of the control devices, in accordance with a predetermined optimization algorithm, with the aim of optimum power distribution.

In addition, the control software preferably has one or more protection modules SM, which autonomously control the protection of the power distribution installation by adjusting or changing the parameters P for definition of the method of operation of the field devices, of the station devices and of the control devices in accordance with the predetermined optimization algorithm, with the aim of an optimum protection effect.

The power distribution modules EM are preferably designed such that they autonomously check—for example regularly, irregularly or on an event-controlled basis—whether relevant power suppliers or power consumers have been added to or removed from the power distribution network, and such that they adapt the parameters P depending on any change which has occurred in the network structure.

FIG. 3 shows a further exemplary embodiment of a power distribution installation 10 according to the invention. In this power distribution installation 10, the field devices, the station devices and the control device are formed by computer devices in the local computer system 100. For example,
the field device 31 shown in FIGS. 1 and 2 is formed by a computer device 31′,
the field device 32 shown in FIGS. 1 and 2 is formed by a computer device 32′.
the field device 33 shown in FIGS. 1 and 2 is formed by a computer device 33′,
the field device 34 shown in FIGS. 1 and 2 is formed by a computer device 34′,
the station device 41 shown in FIGS. 1 and 2 is formed by a computer device 41′.
the station device 42 shown in FIGS. 1 and 2 is formed by a computer device 42′, and
the control device 51 shown in FIGS. 1 and 2 is formed by a computer device 51′.

In the embodiment variant shown in FIG. 3, each field, station and control device is formed by a single individual computer device. Alternatively, individual devices or all or these devices may also be formed by a plurality of computer devices in the local computer system 100, or their functionality may be distributed between a plurality of computer devices in the local computer system 100. It is also possible for individual computer devices or all of the computer devices in the local computer system 100 to entirely or partially provide or map the functionality of two or more field, station and control devices.

The control software, which controls the power distribution through the power distribution installation 10 and/or the protection of the power distribution installation 10, is distributed between one or more of the computer devices—in this case by way of example the computer devices 101 and 102. The control software is formed by control software modules SW1 and SW2.

The purpose of the control software modules SW1 and SW2 is, inter alia, to adjust and/or to change the parameters for definition of the method of operation of the field devices, of the station devices and of the control device, and to store the respectively valid parameters P in the local computer system 100. Preferably, the control software modules SW1 and SW2 store the parameters P for the field, station or control devices in those computer devices in the local computer system 100 which are physically closest to the respective field, station or control devices, thus resulting in the parameters being distributed between at least two different computer devices in the local computer system 100. In the exemplary embodiment shown in FIG. 3, by way of example, the parameters P are stored distributed between the computer devices 103 and 104.

Preferably, the control software modules SW1 and SW2 each have one or more power distribution modules, which autonomously control the power distribution through the power distribution installation, at least as a function of the power availability and the power demand, by adjusting or changing the parameters P for definition of the method of operation of the field devices, of the station devices and of the control devices in accordance with a predetermined optimization algorithm, with the aim of optimum power distribution. The power distribution modules which, for example, may correspond to those shown in FIG. 2 or may be identical or similar to them, are not shown explicitly in FIG. 3, for the sake of clarity.

Alternatively, or additionally, the control software modules SW1 and SW2 preferably have one or more protection modules, which autonomously control the protection of the power distribution installation by adjusting or changing the parameters P for definition of the method of operation of the field devices, of the station devices and of the control devices in accordance with a predetermined optimization algorithm, with the aim of an optimum protection effect. The protection modules which, for example, may correspond to those shown in FIG. 2 or may be identical or similar to them, are not shown explicitly in FIG. 3, for the sake of clarity.

1-15. (canceled)

16. A power distribution installation, comprising:
a field device level having field devices;
a hierarchically superordinate station level having station devices;
a communication network;
a control level being hierarchically superordinate to said station level and having control devices, a method of operation of said field devices of said field level, a method of operation of said station devices of said station level, and a method of operation of said control devices of said control level being defined by parameters;
a multiplicity of separate computer devices connected to one another via said communication network and form a local computer system having said computer devices for the power distribution installation;
said field devices of said field level, said station devices of said station level and said control devices of said control level are connected to said local computer system or are formed by at least one of said computer devices in said local computer system; and
the parameters for defining the method of operation of said field devices, of said station devices and of said control devices are distributed between at least two different ones of said computer devices in said local computer system, and said field devices, said station devices and said control devices access the parameters via said communication network.

17. The power distribution installation according to claim 16, further comprising control software for at least one of controlling power distribution by the power distribution installation or for protecting the power distribution installation, said control software sets or changes the parameters for defining the method of operation of the field devices, of the station devices and of the control devices, said control software being distributed between different ones of said computer devices in said local computer system.

18. The power distribution installation according to claim 17, wherein:
said control software has power distribution modules for controlling the power distribution by the power distribution installation at least in dependence on power availability and a power demand by setting or changing the parameters autonomously; and
said control software has protection modules for autonomously controlling protection of the power distribution installation by setting or changing the parameters.

19. The power distribution installation according to claim 18, wherein said control software has a central management program part which checks at least one of an association of said power distribution modules or of said protection modules with individual ones of said computer devices in said local computer system, and if necessary changes them, in dependence on at least one of instantaneous availability or of instantaneous operating status of said computer devices, regularly, irregularly or on an event-controlled basis.

20. The power distribution installation according to claim 19, wherein local sections of the power distribution installation are associated with at least one of individual ones of said power distribution modules or individual ones of said protection modules, for which said power distribution modules control the power distribution in dependence on local power availability and local power demand, and said protection modules locally control the protection.

21. The power distribution installation according to claim 20, wherein said central management program part is configured to choose the association of at least one of said power distribution modules or of said protection modules with said computer devices in said local computer system in dependence on a geographic location of said computer devices and a geographic location of the local sections, to be precise such that, for an association of said power distribution modules and of said protection modules with said computer devices, said computer devices which are located in a respective local sections or said computer devices which are adjacent thereto are preferred over said computer devices which are further away from the respective local sections.

22. The power distribution installation according to claim 18, wherein at least one of said power distribution modules is suitable for predicting a future power demand in its local section.

23. The power distribution installation according to claim 18, wherein at least one of said power distribution modules or said protection modules are each associated with a single one of said computer devices in said local computer system.

24. The power distribution installation according to claim 19, wherein said central management program part is distributed between at least two of said computer devices in said local computer system.

25. The power distribution installation according to claim 24, wherein said central management program part is formed by management program part modules which are associated with at least two of said computer devices in said local computer system.

26. The power distribution installation according to claim 17, wherein said control software has control software modules which are each associated with a single one of said computer devices in said local computer system.

27. The power distribution installation according to claim 16, wherein a communication connection between at least two of said computer devices in said local computer system or between at least one of said field devices at said field level, one of said station device at said station level or one of said control devices at said control level and at least one of said computer devices in said local computer system is provided redundantly.

28. The power distribution installation according to claim 16, wherein communication via said communication network at least also takes place in accordance with an IEC61850 Protocol.

29. A method for operating a power distribution installation having a field device level, a hierarchically superordinate station level and a control level being hierarchically superordinate to the station level, a method of operation of field devices in the field level, a method of operation of station devices in the station level, and a method of operation of control devices in the control level being defined by parameters, which comprises the steps of:
distributing the parameters for defining the method of operation of the field devices, of the station devices and of the control devices between at least two different computer devices in a local computer system; and
the field devices, the station devices and the control devices access the parameters via a communication network.

30. The method according to claim 29, wherein:
local sections of the power distribution installation are associated with at least one of individual power distribution modules or individual protection modules (SM) for which the power distribution modules locally control the power distribution and the protection modules locally control the protection; and
an association of at least one of the power distribution modules or of the protection modules with the computer devices in the local computer system is chosen in dependence on a geographic location of the computer devices and a geographic location of the local sections, to be precise such that, for an association of at least one of the power distribution modules or of the protection modules with the computer devices, the computer devices which are disposed in the local sections, which are associated with the power distribution modules and the protection modules, or in a vicinity thereof are preferred over the computer devices which are further away.
